(19) United States
(12) Patent Application Publication
(10) Pub. No.: US 2005/0150763 A1
(43) Pub. Date: Jul. 14, 2005

(54) Biosensor and method of manufacture

(76) Inventors: Colin W. Butters, Ipswich (GB); Wah On Ho, Colchester (GB); Christopher J. Mayne, Ipswich (GB); John J. Rippeth, Ipswich (GB)

Correspondence Address: O'KEEFE, EGAN & PETERMAN, L.L.P.;Building C, Suite 200, 1101 Capital of Texas Highway South, Austin, TX, 78746, US

(21) Appl. No.: 11/028,942

(22) Filed: Jan. 4, 2005

Related U.S. Application Data
(60) Provisional application No. 60/535,430, filed on Jan. 9, 2004.

(51) Int. Cl. G01N 27/26

(52) U.S. Cl. 204/403.01; 204/403.14

(57) ABSTRACT

A non-mediated biosensor for indicating amperometrically the catalytic activity of an oxidoreductase enzyme in the presence of a fluid containing a substance acted upon by said enzyme, the biosensor comprising: (a) a first substrate; (b) a working electrode and a counter electrode on the first substrate; (c) conductive tracks connected to said electrodes for making electrical connections with a test meter apparatus; (d) a second substrate overlying at least a part of the first substrate; and (e) a spacer layer having a channel therein and disposed between the first substrate and the second substrate, the spacer layer channel co-operating with adjacent surfaces to define a capillary flow path which does not contain a mesh and which extends from an edge of at least one of said substrates to said electrodes; wherein the working electrode includes: (f) an electrically-conductive base layer comprising particles of finely divided platinum-group metal or platinum-group metal oxide bonded together by a resin; (g) a top layer on the base layer, said top layer comprising a buffer; and (h) a catalytically-active quantity of said oxidoreductase enzyme in at least one of said base layer and said top layer.

This application claims priority to co-pending U.S. provisional application Ser. No. 60/535,430 filed on Jan. 9, 2004, which is entitled “BIOSENSOR AND METHOD OF MANUFACTURE” the disclosure of which is incorporated herein by reference.

### BACKGROUND OF THE INVENTION

1. Field of the Invention

The present invention relates to biosensors for measuring analyte concentration in fluids, for example glucose in whole blood. The invention also provides a method of manufacturing the biosensor. Biosensors typically include an enzyme electrode comprising an enzyme layered on or mixed with an electrically conductive substrate. The electrodes respond amperometrically to the catalytic activity of the enzyme in the presence of a suitable analyte.

2. Description of the Prior Art

Amperometric biosensors are well known in the art. Typically the enzyme is an oxidoreductase, for example glucose oxidase, cholesterol oxidase, or lactate oxidase, which produces hydrogen peroxide according to the reaction:
analyte+O₂−[oxidase]→oxidised product+H₂O₂.

The peroxide is oxidised at a fixed-potential electrode as follows:
H₂O₂→O₂+2H⁺+2e^{-.}

Electrochemical oxidation of hydrogen peroxide at platinum centres on the electrode results in transfer of electrons from the peroxide to the electrode producing a current which is proportional to the analyte concentration. Where glucose is the analyte, the oxidised product is gluconolactone. Japanese Unexamined Patent Publication No. 56-163447 describes a system which employs glucose oxidase immobilised on a platinum electrode. The electrode comprises a layer of immobilised enzyme on an electrically conductive carbon base. The base is formed from moulded graphite containing up to 10 parts by weight of a fluorocarbon resin binder, onto which is deposited a thin (less than 1 μm) platinum film. The invention is said to avoid the problems associated with the immobilisation of the enzyme directly onto the platinum surface and to produce an enzyme electrode having rapid response times (5 seconds), high sensitivity and durability. However, according to U.S. Pat. No. 4,970,145, recent experimental work with such electrodes has failed to elicit such benefits.

U.S. Pat. No. 4,970,145 describes an enzyme electrode comprising a substantially heterogeneous porous substrate consisting essentially of resin-bonded carbon or graphite particles with a platinum-group metal dispersed substantially uniformly throughout the substrate, and a catalytically active quantity of an enzyme adsorbed or immobilised onto the surfaces of the porous substrate. The electrodes are manufactured either by cross-linking the enzyme to the substrate, or by suspending the porous substrate in a buffered solution of the enzyme for 90 minutes at room temperature. Alternatively, adsorption of the enzyme to the electrode is effected by electroadsorption, wherein the electrode base material is suspended at a positive potential in an enzyme solution for 60 minutes. The electrode is said to have fast response times (1-2 seconds without a protective membrane, and 10 to 30 seconds with a membrane) and good stability. The working range is said to be extended, and the electrode requires a substantially lower operating potential than normal (325 mV against the more usual 650 mV) and exhibits low background at the operating potential.

U.S. Pat. No. 5,160,418 discloses a simplified enzyme electrode comprising a thin film of a substantially homogeneous blend of enzyme and finely-divided platinum group metal or oxide. Optionally, platinised or palladised finely-divided carbon or graphite may be used and, also optionally, a binder. The film can be made by screen-printing a liquid suspension containing the components.

We have found that prior art systems such as described above have high intercepts relative to sensitivity, resulting in poor calibrated precision. We have also found that there is a gradual attenuation of sensitivity with time which is not necessarily related to enzyme instability.

As an alternative to measurement of an electrical signal following transfer of electrons from peroxide to the electrode, some biosensors include an electron carrier, or “mediator” which, in an oxidised form, accepts electrons from the enzyme and then, in a reduced state, transports the electrons to the electrode where it becomes re-oxidised.

Prior art examples of mediators include ferrocene, ferrocene derivatives, ferricyanide, osmium complexes, 2,6-dichlorophenolindophenol, Nile Blue, and Medola Blue; see, for example: U.S. Pat. No. 5,708,247, U.S. Pat. No. 6,241,862, U.S. Pat. No. 6,436,256, WO 98/55856, and WO 99/13100. Biosensors that employ a redox mediator to transfer electrons between the enzyme and the electrode will be referred to as “mediated biosensors”.

Mediated biosensors can suffer from a number of problems, including chemical instability. The mediator must be in a particular redox state to function, so that if the reduced form is oxidised by air the measured current will be reduced. Oxygen may also interfere by accepting electrons to form peroxides which are not oxidised at the potential of the mediated electrode. If the electrode potential is increased to oxidise the peroxide, this makes the system prone to interference from other species which may be dissolved in blood, for example paracetamol, ascorbate, and uric acid. Thus, variation in oxygen concentration in blood may cause variation in measured glucose response in a mediated system.

Desirable attributes for a single use biosensor include:
low intercept, related to background—to achieve low coefficients of variation (CV's) after calibration;
as high a sensitivity as the electronics will allow;
stability;
good precision;
reproducible manufacture;
rapid response;
low cost.

It is also desirable that a biosensor can take a sufficiently accurate reading using a small sample volume (for example, a reading of blood glucose concentration from a whole blood sample less than a few microlitres). In U.S. Pat. No. 6,436,256, a biosensor requiring a small sample volume (less than 2 microlitres) is achieved by a mediated biosensor having a multilayer structure. The structure comprises two substrates separated by a printed spacer layer and forming a cavity which is open at one end for introduction of a sample. The cavity is filled with a monofilament mesh which is laid over the spacer layer and is coated with a surfactant or chaotropic agent. The mesh covers working and reference electrodes and extends beyond the upper substrate to provide an exposed area of mesh at one end. Application of a fluid sample to the exposed area floods the mesh and the fluid is carried to the electrodes by capillary action through the mesh.

The presence of a mesh can facilitate spreading of reagents on the working electrode during manufacture of the biosensor, but it adds complexity to the manufacturing process. Spreading of a reagent beyond the working electrode also means that more reagent is required to ensure that the working electrode is adequately treated.

The present invention seeks to provide an enzyme electrode and biosensor which are improved in respect of at least some of the above criteria.

### SUMMARY OF THE INVENTION

According to an aspect of the invention there is provided a non-mediated biosensor for indicating amperometrically the catalytic activity of an oxidoreductase enzyme in the presence of a fluid containing a substance acted upon by said enzyme, the biosensor comprising:
(a) a first substrate;
(b) a working electrode and a counter electrode on the first substrate;
(c) conductive tracks connected to said electrodes for making electrical connections with a test meter apparatus;
(d) a second substrate overlying at least a part of the first substrate; and
(e) a spacer layer having a channel therein and disposed between the first substrate and the second substrate, the spacer layer channel co-operating with adjacent surfaces to define a capillary flow path which does not contain a mesh and which extends from an edge of at least one of said substrates to said electrodes;
   wherein the working electrode includes:
(f) an electrically-conductive base layer comprising particles of finely divided platinum-group metal or platinum-group metal oxide bonded together by a resin;
(g) a top layer on the base layer, said top layer comprising a buffer; and
(h) a catalytically-active quantity of said oxidoreductase enzyme in at least one of said base layer and said top layer.

The term “non-mediated” is used herein to refer to a biosensor having a working electrode which does not contain any significant quantity of a redox mediator. Preferably, the working electrode does not contain any redox mediator. Thus, when an oxidoreductase enzyme such as glucose oxidase is employed, all or substantially all of the measured current results from oxidation of peroxide at the electrode.

Because the capillary flow path does not include a mesh an applied fluid containing the buffer is not carried away from the working electrode by wicking. The biosensor may be manufactured with a smaller quantities of buffer and/or other species in the top layer. The spacer may be relatively thin, for example 60-120 μm to reduce the capillary flow path volume so the biosensor may require smaller sample volumes. This enables the biosensor to be used at alternative sample sites on a subject's body. A blood sample is typically taken by pricking a subject's finger to provide a relatively large drop of blood for application to a conventional biosensor. Because a fingertip has a relatively large number of nerve endings, pricking the fingertip can be painful and deters some subjects from testing their blood glucose level often enough. A biosensor in accordance with the present invention may be used to take a reading from an alternative site, for example a subject's upper arm which has fewer nerve endings so that sampling is less painful. The sample volume may be as low as about 0.8 μl.

To facilitate collection of small sample volumes it is preferred that the capillary flow path runs from opposed edges of both substrates to the electrodes, so that there is no lip where one substrate extends beyond the other at the point where the sample is introduced into the biosensor. The presence of a lip provides a wasted space on which some or all of the sample may remain.

To encourage capillary filling of the biosensor at least one of the major surfaces defining the capillary flow path should be hydrophilic so that it is readily wetted by a biological fluid such as whole blood.

We have found that by providing the buffer in the top layer, we can get faster response times than conventional non-mediated biosensors, together with increased stability and sensitivity. The increase in sensitivity and response time we believe is achieved by providing a high buffering capacity on the strip. The oxidation of hydrogen peroxide produces hydrogen ions which are neutralised by the buffer. This can have two effects: it sustains enzyme activity by maintaining the local pH around the enzyme, and it also shifts the equilibrium of the hydrogen peroxide oxidation making it more efficient. Improving the efficiency of hydrogen peroxide oxidation also results in greater oxygen recycling which can be utilised by the oxidoreductase enzyme. We have also found that the ratio of enzyme to buffer is important in obtaining a desirable linearity of response and to obtain a reasonable lower limit of sensitivity. We have further found that the buffer and enzyme needs to exceed a particular threshold concentration to attain the maximum sensitivity and above this concentration the ratio of buffer to enzyme can be used to “tune” the profile of the response of the biosensor to blood glucose, as will be discussed later in the context of our experimental results.

Preferred buffers include: phosphate, ADA, MOPS, MES, HEPES, ACA, and ACES, or buffers with a pKa 7.4±1. The pH range for the buffer will depend on the specific chemistry of the system. A preferred range is pH 7-10, notably 7 to 8.5. Particularly preferred buffers are phosphate, at about pH 8, and ADA at about pH 7.5.

The platinum group metal or oxide may be present in sufficient quantity for the base layer to be electrically conductive, as taught in U.S. Pat. No. 5,160,418. Alternatively, the base layer may also contain particles of finely divided carbon or graphite. For convenience, the term “catalyst” will be used herein to refer to the finely divided platinum-group metal or platinum-group metal oxide. The catalyst may be carried on the surface of the carbon or graphite particles. In a preferred embodiment, the catalyst is in intimate surface contact with the carbon or graphite particles, for example as platinised carbon or palladised carbon. The catalyst may be adsorbed, crystallised or deposited on the surface of the particles.

The resin may comprise any compatible binder material or bonding agent which serves to bond the platinum group metal or oxide in the base layer; for example, a polyester resin, ethyl cellulose or ethylhydroxyethylcellulose (EHEC).

The working electrode may be manufactured by printing an ink containing the catalyst on the base substrate, allowing the printed ink to dry to form a base layer, and subsequently forming the top layer by applying a coating medium comprising or containing the buffer. The coating medium is preferably a fluid, notably an aqueous fluid in which the buffer is dissolved. However, the coating medium could comprise a dry powder consisting of or containing the buffer, which is applied, for example by spraying, to a tacky base layer. Suitable methods for forming the top layer when a coating fluid is applied include printing, spraying, ink jet printing, dip-coating or spin-coating. A preferred coating technique is drop-coating of a coating fluid, and the invention will be described hereinafter with reference to this preferred method. By accurately drop-coating a coating fluid onto the base layer, the volume of coating fluid required may be reduced, for example to 125 nl.

In a preferred embodiment, the enzyme is provided in the top layer with the buffer. This arrangement facilitates adjustment of the pH in the local environment of the top layer to a level at which the enzyme may operate more efficiently, which level is typically different from that at which the platinum group metal or oxide optimally operates.

A system stabiliser may advantageously be included in the top layer. Suitable stabilisers include polyols other than those which are acted upon by the enzyme; for example trehalose, mannitol, lactitol, sorbitol or sucrose where the enzyme is glucose oxidase. The system stabiliser may stabilise the enzyme by encapsulation, hindering tertiary structural changes on storage, or by replacing the water activity around the enzyme molecule. The glucose oxidase enzyme has been shown to be a very stable enzyme and the addition of stabilisers are not primarily to protect this enzyme. The stabiliser is believed to help reduce long term catalyst passivation effects, for example by coating a platinised carbon resin base layer as well as blocking the carbon surface to air oxidation.

If carbon particles are present in the base layer, a blocking agent may optionally be included in that layer to block active sites on the carbon particles. This aids shelf stability and uniformity of the carbon's activity. Suitable blocking agents include the system stabilisers and also proteins, for example bovine serum albumin (BSA). If graphite particles are used instead of high surface carbon, the particles have higher conductivity, and a blocking agent is less desirable because the number of active moieties on the graphite is much less than that found on carbon. The smaller surface area and less active surface groups both tend to reduce the intercept. At 0 mM of analyte the intercept consists mainly of a capacitative component which is surface area related.

The substrates may be formed from any suitably heat-stable material which is compatible with the coating to be applied. Heat stability is important to ensure good registration of prints in the manufacturing process. A preferred substrate is Valox FR-1 thermoplastic polyester film (poly(butylene terephthalate) copoly (bisphenol-A/tertabromobisphenol-A-carbonate). Other suitable substrates will be well known to those skilled in the art, for example PVC, poly (ether sulphone) (PES), poly (ether ether ketone) (PEEK), and polycarbonate.

The enzyme may be any suitable oxidoreductase enzyme; for example glucose oxidase, cholesterol oxidase, or lactate oxidase.

According to another aspect of the present invention there is provided a method of manufacturing a non-mediated biosensor for indicating amperometrically the catalytic activity of an oxidoreductase enzyme in the presence of a fluid containing a substance acted upon by said enzyme, the method comprising the steps of:
(a) taking a first substrate having a working electrode and a counter electrode thereon, and conductive tracks connected to said working and reference electrodes for making electrical connections with a test meter apparatus;
(b) wherein said working electrode is formed by printing on one of said conductive tracks an ink containing finely divided platinum-group metal or platinum-group metal oxide and a resin binder;
(c) causing or permitting said printed ink to dry to form an electrically conductive base layer comprising said platinum-group metal or platinum-group metal oxide bonded together by the resin;
(d) forming a top layer on the base layer by coating the base layer with a coating medium comprising or containing a buffer; wherein
(e) a catalytically active quantity of said oxidoreductase enzyme is provided in at least one of the printed ink and the coating medium;
(f) providing a second substrate overlying part of the first substrate; and
(g) providing a spacer layer having a channel therein and disposed between the first substrate and the second substrate, whereby the spacer layer channel and adjacent surfaces together define a capillary flow path which does not contain a mesh and which extends from an edge of at least one of said substrates to said electrodes.

In a preferred embodiment the counter electrode also functions as a reference electrode, in a manner known per se.

Other aspects and benefits of the invention will appear in the following specification, drawings and claims.

### BRIEF DESCRIPTION OF THE DRAWINGS

The invention will now be further described, by way of example, with reference to the following drawings in which:

FIGS. 1-4 show stages in the formation of biosensors in accordance with different embodiments of the present invention;

FIG. 5 is a graph showing current responses of different enzyme loadings on a biosensor in accordance with an aspect of the present invention;

FIG. 6 is a graph showing effects of enzyme loading on venous blood glucose response for a specified buffer;

FIG. 7 is a graph illustrating the effect of trehalose drop-coat concentration on venous blood glucose response;

FIGS. 8-12 are graphs showing venous blood glucose responses for biosensors in accordance with aspects of the invention, with varying ratios of buffer to enzyme; and

FIG. 13 is a graph showing results for biosensors according to the present invention manufactured by different coating techniques.

### DETAILED DESCRIPTION

Preparation of BSA-Pt/Carbon

In a 250 ml glass bottle, 6.4 g of BSA, Miles Inc. was dissolved in 80 ml of phosphate buffered saline (PBS) and 20 g of 10% Pt/XC72R carbon, MCA Ltd, was gradually added with constant stirring. The bottle was then placed on a roller mixer and allowed to incubate for two hours at room temperature.

A Buchner funnel was prepared with two pieces of filter paper, Whatman™ No 1. The mixture was poured into the funnel and the carbon washed three times with approximately 100 ml of PBS. The vacuum was allowed to pull through the cake of carbon for about 5 minutes to extract as much liquid as possible. The cake of carbon was carefully scraped out into a plastic container and broken up with a spatula. The carbon was then placed in an oven at 30° C. overnight to dry. The purpose of this procedure is to block active sites on the carbon hence to aid the shelf stability and reproducibility of the carbon's properties.

Preparation of Platinum Group Metal/Carbon Inks

BSA-Pt/Carbon was prepared in Metech 8101 polyester resin as the polymer binder and Butyl Cellosolve Acetate (BCA) as a solvent for the ink.

Ink Formulation (I)

| | |
|---|---|
| Metech 8101 resin | 45.32% |
| BSA-Pt/Carbon | 18.67% |
| graphite | 9.77% |
| BCA/cyclohexanone | 23.26% |
| Tween ® 20 | 2.98% |

Tween 20 is a surfactant supplied by Sigma-Aldrich. Tween is a registered trade mark of ICI Americas, Inc. The solvent is a 50% v/v mixture of BCA and cyclohexanone. The graphite was Timrex KS 15 (particle size<16 μm), from GS Inorganics, Evesham, Worcs. UK.

The resin, Tween 20, and about half the solvent were initially blended together prior to adding the carbon fraction and the graphite. Initially the formulation was hand-mixed followed by several passes through a triple roll mill. The remaining volume of solvent was then added to the ink and blended to bring the ink to a suitable viscosity for printing.

A further test formulation included GOD in the ink, as follows.

Ink Formulation (II)

| | |
|---|---|
| Metech 8101 resin | 44.68% |
| BSA-Pt/Carbon | 18.42% |
| graphite | 9.64% |
| BCA/cyclohexanone | 22.94% |
| Tween ® 20 | 2.94% |
| glucose oxidase | 1.38% |

Preparation of Drop-Coating Solutions

The coating solution is water-based and consists of a high concentration of buffer, preferably phosphate at pH 8. It has been found that buffering capacity is more important than ionic strength. In this example the solution contains glucose oxidase and a system stabiliser, in this example trehalose.

Sample Drop-Coat Solution

| Buffer | KH₂PO₄/K₂HPO₄ | 385 mN, pH 8 | Sigma |
|---|---|---|---|
| Enzyme | Glucose oxiclase | 4080 U/ml | Biozyme |
| Stabiliser | Trehalose | 1% | sigma |

Preferred Ranges

| Buffer | 300-1000 mM, pH 7-10 |
|---|---|
| Enzyme | 500-12000 U/ml (1.85-44.4 mg/ml) |
| Stabiliser | 0.5-30% |

The activity of the glucose oxidase is about 270 units per milligram of material (360 units/mg of protein because the enzyme comes in a preparation with other lyophilisation and stabilisation agents).

If the enzyme is located in the base layer, for example in a base layer prepared using Ink Formulation II, the drop coating solution may contain only buffer, optionally with the stabiliser.

Methods of Manufacture

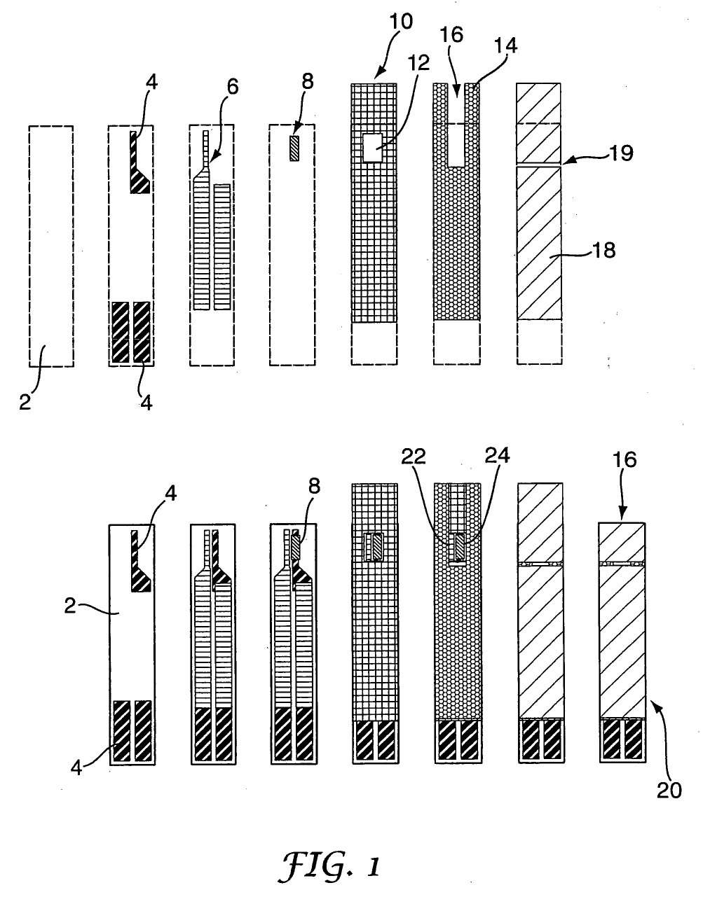

Glucose test strips (biosensors) were manufactured using a combination of screen printing and drop coating technologies. Other printing and/or coating technologies, well known per se to those skilled in the printing and coating arts may also be used. The exemplified methods are by way of illustration only. It will be understood that in each case the order of performance of various steps may be changed without affecting the end product. For each of FIGS. 1-4 the top row illustrates a process step, and the bottom row illustrates the sequential build-up of the biosensor.

With reference to FIG. 1, a base substrate 2 is formed from a polyester (Valox™). Conductive tracks 4 were printed onto the substrate 2 as a Conductive Carbon Paste, product code C80130D1, Gwent Electronic Materials, UK. The purpose of this ink is to provide a conductive track between the meter interface and the reference and working electrodes. After printing, this ink was dried for 1 minute in a forced air dryer at 130° C. The second ink printed on top of the conductive carbon 4 is a Silver/Silver Chloride Polymer Paste, product code C61003D7, Gwent Electronic Materials, UK. This ink 6 is not printed over the contact area or the working area. This ink 6 forms the reference electrode 22 of the system. It is dried at 130° C. in a forced air dryer for 1 minute. It will be appreciated that the term “reference electrode” as used herein refers to a reference electrode which also functions as a counter electrode as is well known in the art as such.

The next layer is the platinum group metal carbon ink (Ink Formulations I or II) which is printed onto the conductive carbon 4. This ink is dried for 1 minute at 90° C. in a forced air dryer to form a conductive base layer 8 about 12 μm thick. A dielectric layer 10 is then printed, excluding a working area 12 in which the working and reference electrodes are to be located. The dielectric layer 10 is MV27, from Apollo, UK. The purpose of this layer is to insulate the system. It is dried at 90° C. for 1 minute in a forced air dryer. If desired, the base layer 8 can alternatively be printed after the dielectric layer 10. However, it is preferred to print the base layer 8 first, since the subsequent application of the dielectric layer 10 removes some of the tolerance requirements of the print.

A drop-coat layer is then applied to the base layer 8 using BioDot drop-coating apparatus. The volume of drop-coating solution used is 125 nl, applied as a single droplet; the drop-coat layer is dried in a forced air dryer for 1 minute at 50° C.

A spacer layer 14 is then applied over the dielectric layer 10. In the example shown in FIG. 1 the spacer layer 14 is formed from double-sided adhesive tape of thickness about 90 μm. The tape was Adhesives Research 90118, comprising a 26 μm PET carrier with two 32 μm AS-110 acrylic medical-grade adhesive layers.

For biosensors which will be stacked on top of each other, for example in a magazine or cartridge in a test meter, it is desirable to reduce or eliminate oozing of adhesive from the edges of the substrates, which might tend to cause adjacent biosensors to adhere to each other. A preferred material for use as the spacer 14 for this purpose is product code 61-89-03 from Adhesives Research Ireland Limited, Raheen Business Park, Limerick, Ireland. The spacer material comprises pressure sensitive adhesive (PSA) 25-29 μm on each side of a 36 μm PET film. A further alternative spacer is product code 64-14-04, also from Adhesives Research Ireland Limited, which has a UV-curable PSA on each side of a 23 μm PET film. The adhesive layers are each 31-35 μm thick. Recommended curing conditions are: D-bulb (Hg doped with Fe), 1 lamp, full power, 20 m/min. belt speed. Expected energy at these settings: UVA 357 J/cm², UVB=0.128 J/cm², UVC=0.010 J/cm².

The spacer 14 has a channel 16 which will determine the capillary flow path of the biosensor. A second substrate, or lid, 18 is adhered to the spacer 14. The lid 18 comprises a 50 μm PET tape (Adhesive Research 90119) coated with about 12.5 μm of a hydrophilic heat-seal adhesive ‘HY9’. The lid 18 is provided with a narrow vent 19 to permit the exit of air from the capillary flow path. Finally, the second substrate 18 is guillotined to produce the final biosensor 20. Alternatively the spacer 14 could, of course, be initially adhered to the second substrate 18 and then adhered to the first substrate. A benefit of this arrangement is that the second substrate 18 may be cut to provide the vent 19 while both parts of the second substrate 18 are held in the correct positions by the spacer 14.

The biosensor 20 has a reference electrode 22 and a working electrode 24. The working electrode 24 comprises the base layer 8 on a conductive carbon layer 4 on the first substrate 2, and a top layer including the buffer.

In large-scale manufacturing, a plurality of substrates may be provided initially connected together on a single blank or web, preferably two substrate-lengths deep, and the various processing steps carried out on the entire blank or web, followed by a final separation step to produce a plurality of biosensors 20.

The biosensor 20 has a capillary flow path defined by the channel 16 in the spacer 14, the inner surface of the lid 18, and the first substrate 2 (largely covered by the dielectric layer 10). The flow path extends from the opposed short edges of each of the substrates 2, 18 to the reference and working electrodes 22, 24. The inner surface of the lid 18 is treated to be hydrophilic to facilitate wetting by blood. With glucose oxidase as the enzyme, the biosensor is used to measure blood glucose. A user may take a reading by pricking an alternative site such as his or her upper arm to produce a small drop of blood on the skin, and touching the appropriate short edge of the biosensor 20 to the skin where the blood is located. The blood is drawn rapidly to the working area 12, producing a current readable by a meter (not shown) connected to the conductive tracks 4 in a known manner. A sample volume of about 0.8 nl is sufficient.

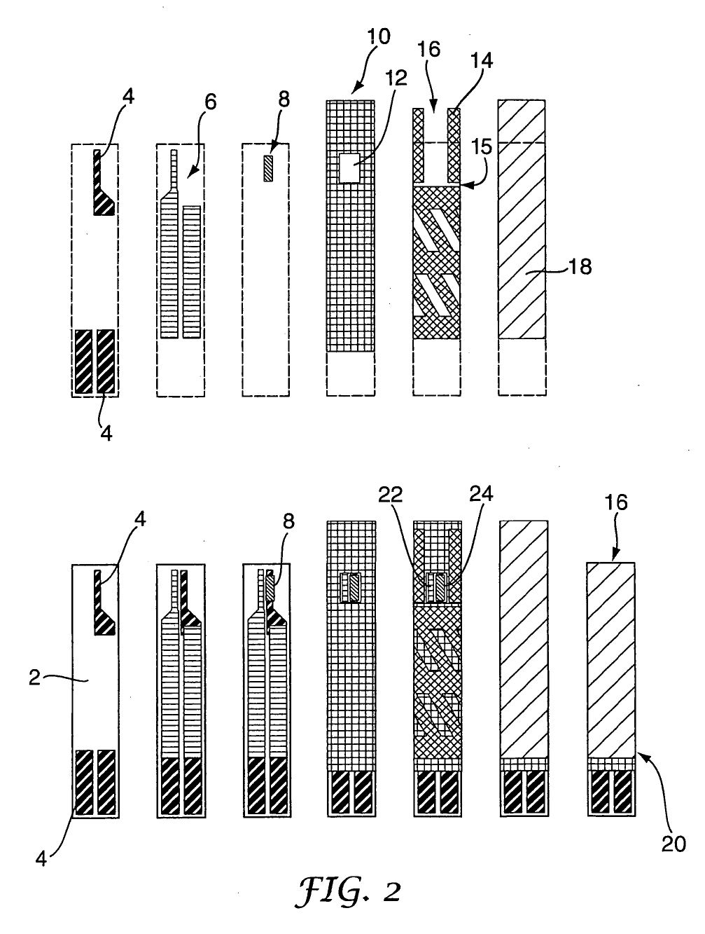

An alternative embodiment is shown in FIG. 2. The process steps are the same as for FIG. 1 except as follows. The spacer 14 is formed by screen-printing a UV-curable resin (Nor-Cote 02-060 Halftone Base) on the dielectric layer 10 and then curing the resin with UV light (120 W/cm medium pressure mercury vapour lamp) at up to 30 m/min. The resin comprises acrylated oligomers (29-55%) N-vinyl-2-pyrrolidone (5-27%) and acrylated monomers (6-28%). In addition to the channel 16, the spacer 14 has a vent channel 15 for allowing air to exit the capillary flow path. The lid 18 does not require a vent exit, and is formed as a single unit having an inner surface coated with a hydrophilic heat-sealable adhesive (Adhesive Research 90119 coated with ‘HY9’). The lid 18 is adhered to the spacer 14 by the action of heat and pressure (100° C., 400 kPa) for 1-2 seconds.

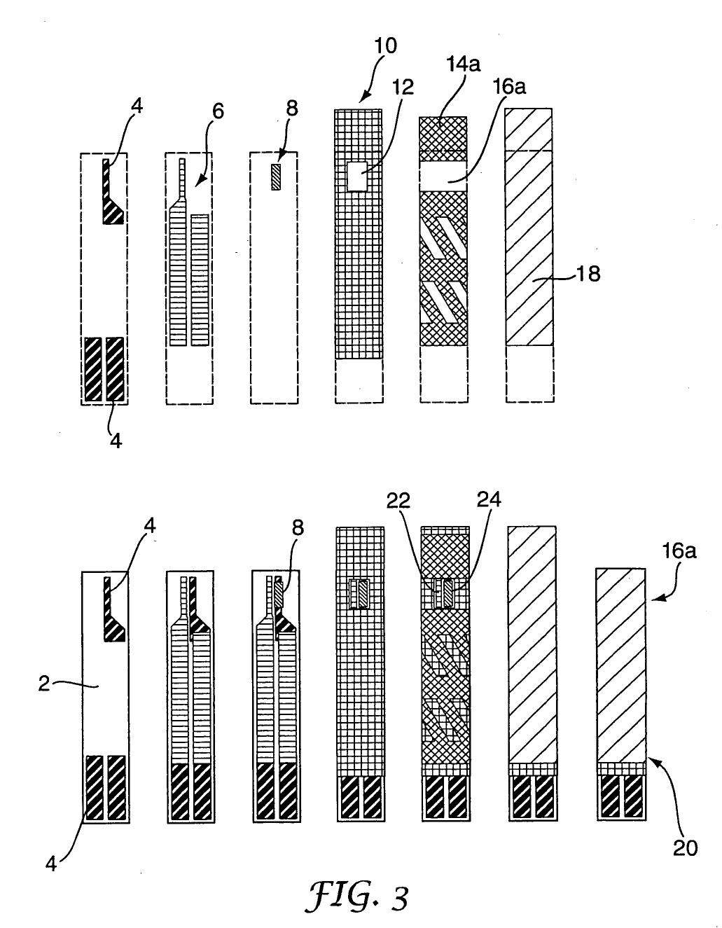

Referring now to FIG. 3, a further embodiment is illustrated. This embodiment has the same structure as that of FIG. 2, but in the spacer 14a (formed from the same UV-curable resin as for FIG. 2), the channel 16a extends from one long edge to the other. This arrangement provides a capillary opening at one long edge and an air vent opening at the other.

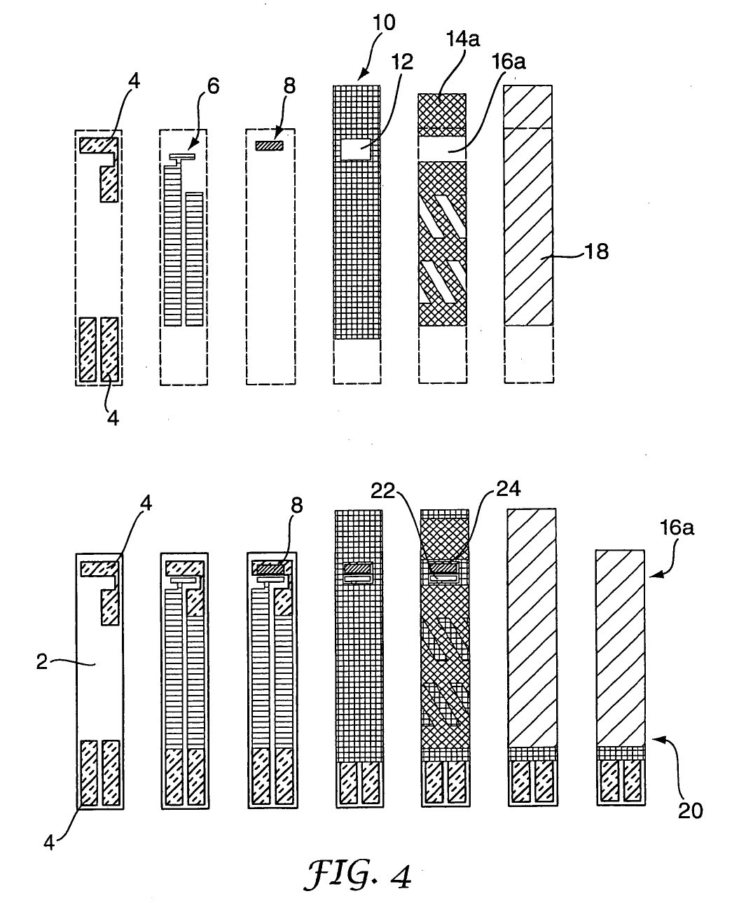

The biosensor of FIG. 4 has a similar construction to that of FIG. 3, but the conductive tracks 4, conductive ink 6 and base layer 8 are arranged so that the working electrode 24 and reference electrode 22 are disposed side-by-side in the flow path. This arrangement has a similar effect to that shown in FIGS. 1 and 2, but with sample application via an opening in one long edge of the biosensor. Blood flowing through the capillary path will flow substantially evenly and simultaneously over both electrodes, which is desirable for reproducibility and accuracy.

Test Procedure

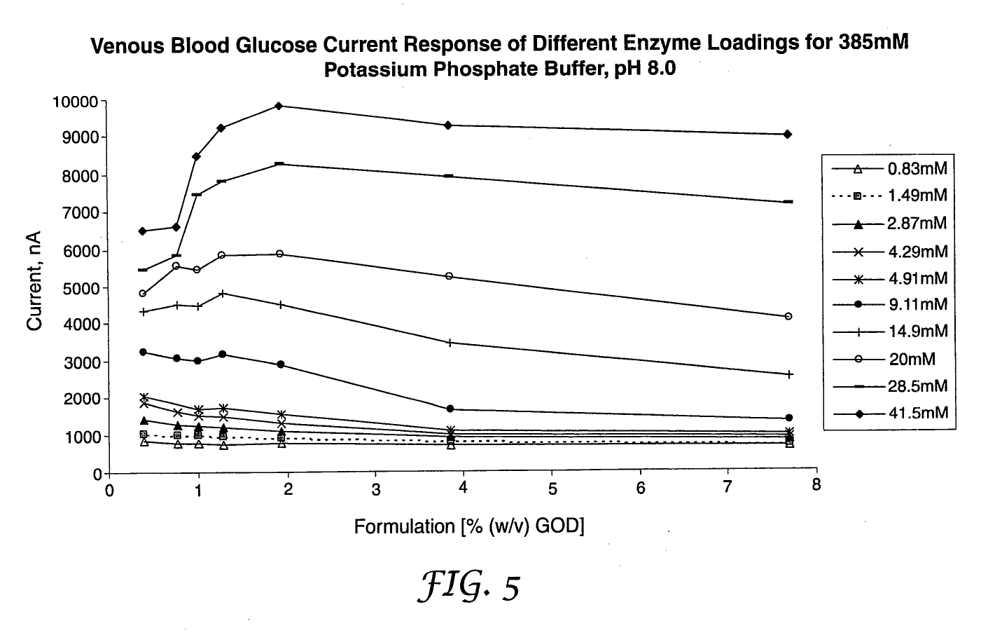

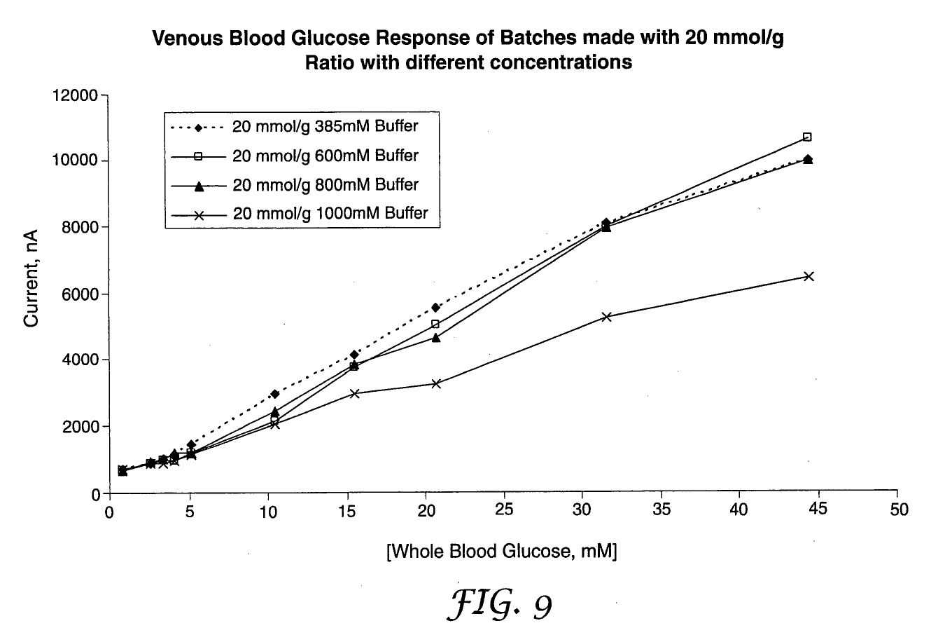

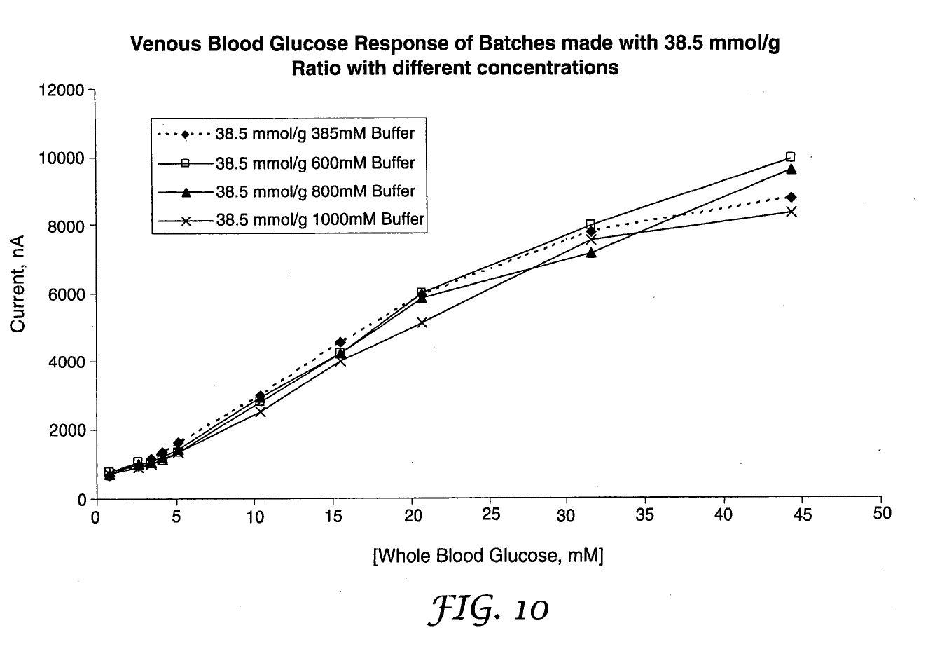

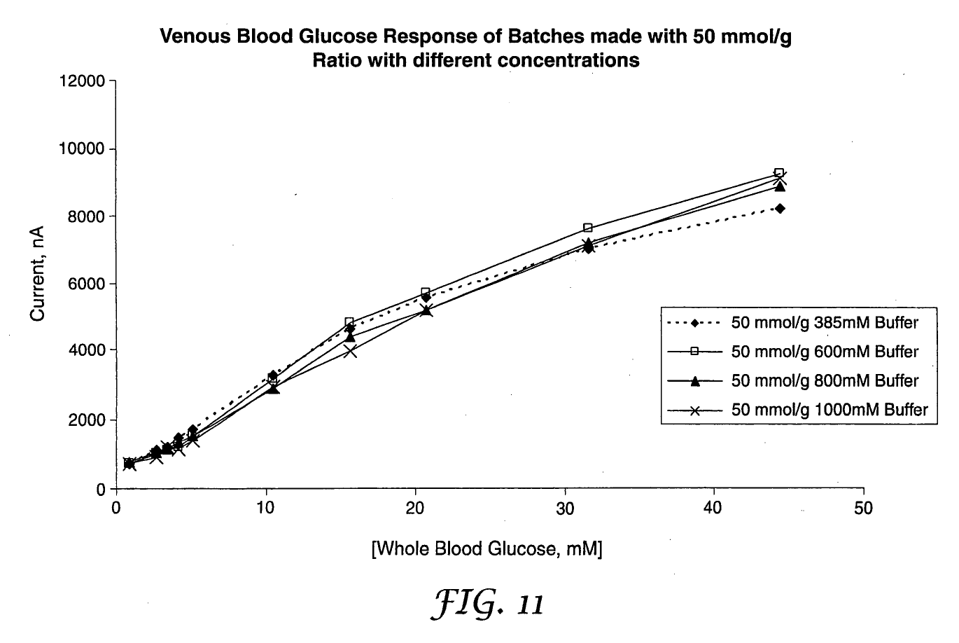

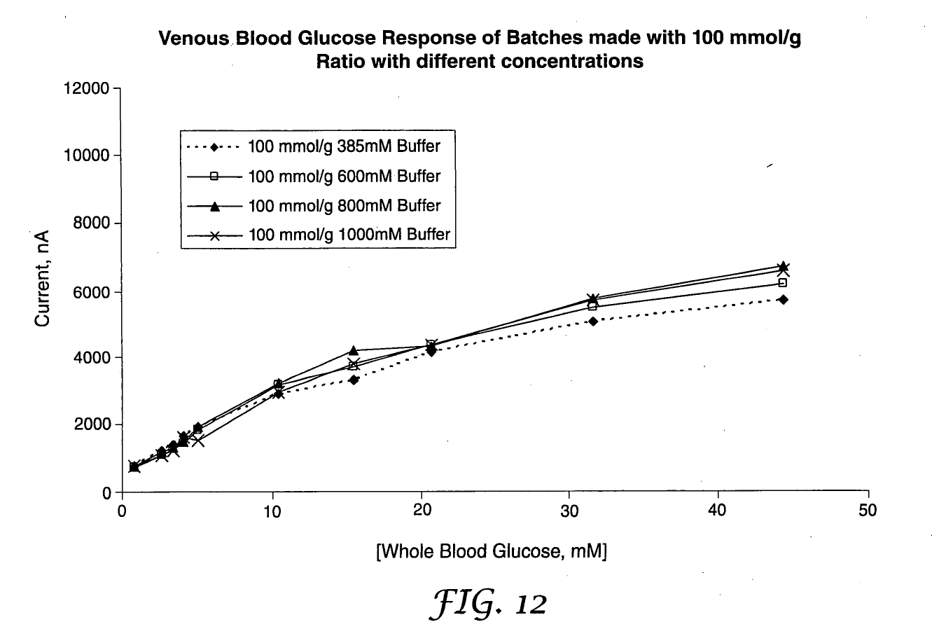

The test procedure involves connecting the test strips to a potentiostat. A potential of 350 mV is applied across the working and reference electrodes after application of a sample, in this example a sample of venous whole blood (WB). The potential is maintained for 15 seconds, after which the current is measured; this current is used to prepare response graphs. Results for FIGS. 5 to 13 were obtained using Ink Formulation I and different drop-coat formulations, each containing GOD and buffer. The test strips had the construction illustrated in FIG. 1. After drop-coating (125 nl), the partially-constructed test strips were allowed to condition for four days at room temperature and low humidity prior to lamination, cutting and potting.

FIG. 5 shows results for changes in GOD level (ratio of buffer to enzyme) for a 385 mM potassium phosphate buffer.

In each solution trehalose was present at the same concentration (grams per 100 ml) as GOD. Results are plotted for venous blood glucose concentrations from 0.83 mM to 41.5 mM. The results show that increasing GOD (decreasing the buffer/enzyme ratio from about 20 mmol/g) gives an increase in glucose sensitivity over the higher glucose concentration range. Further experiments with the buffer concentration increased by up to 800 mM suggest that this improves stability a small amount as there appears to be less of a change than at 385 mM or 600 mM. However, increasing the concentration of GOD (decreasing the ratio) is likely to have a greater effect in improving strip stability. Increasing the GOD level will have an impact on low glucose concentration sensitivity, making the response flatten. Thus increasing the enzyme loading may improve test strip stability but at the possible cost of reducing bottom end sensitivity.

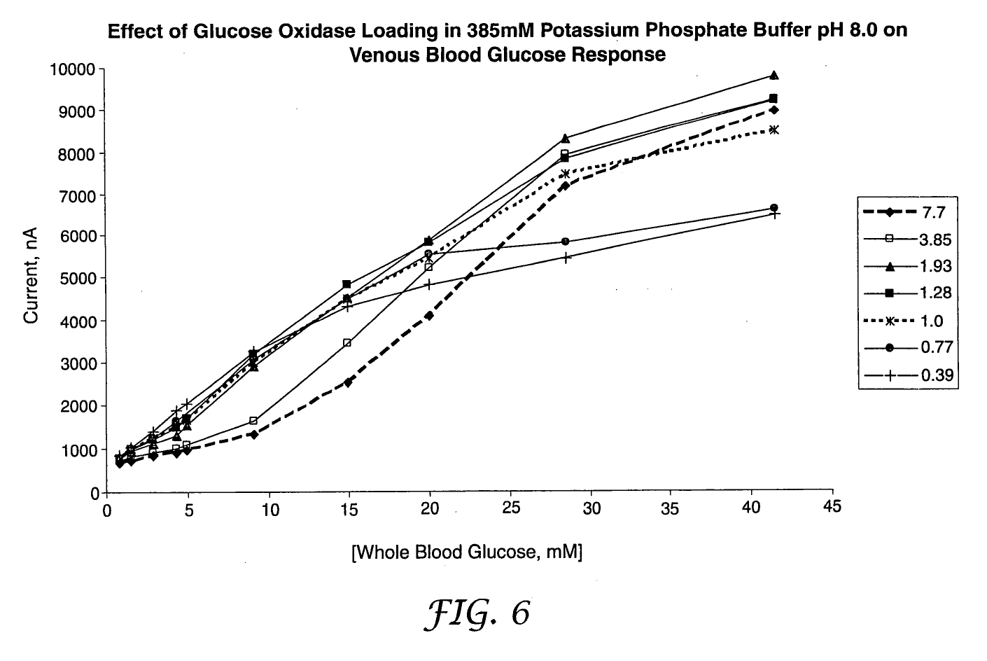

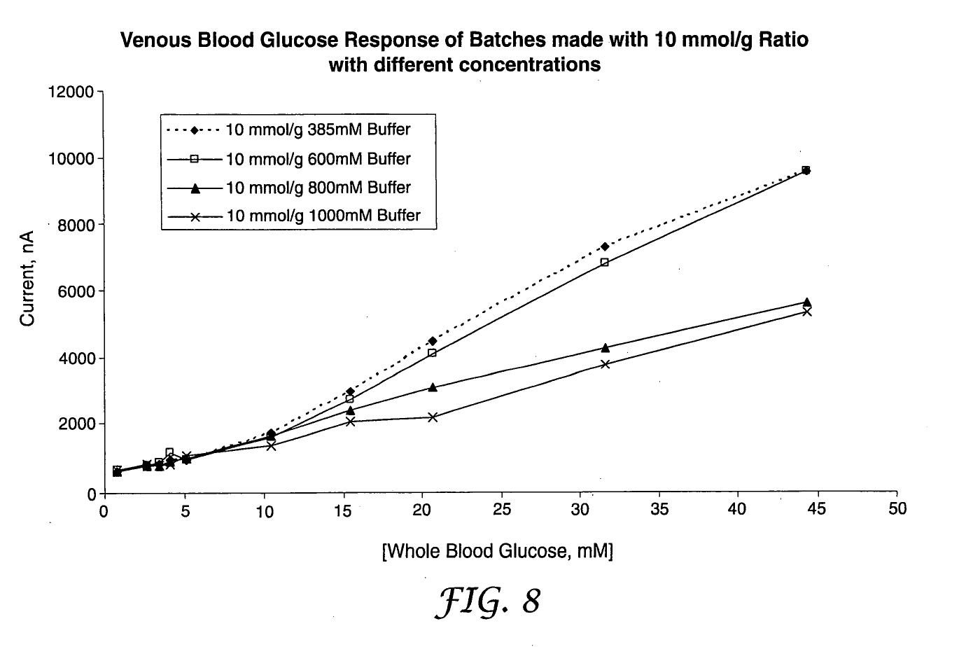

FIG. 6 plots results for changes in GOD loadings between 0.39 and 7.7 grams per 100 ml and equal amounts of trehalose. A decrease in GOD gives improved low concentration response. We have also found that a combination of high GOD and high buffer concentration tends to lower the response across a range of glucose levels. This effect may be observed from FIGS. 8-12, which plot results for changing the ratio of buffer to enzyme (mmol/g) at different concentrations in the drop-coat solution.

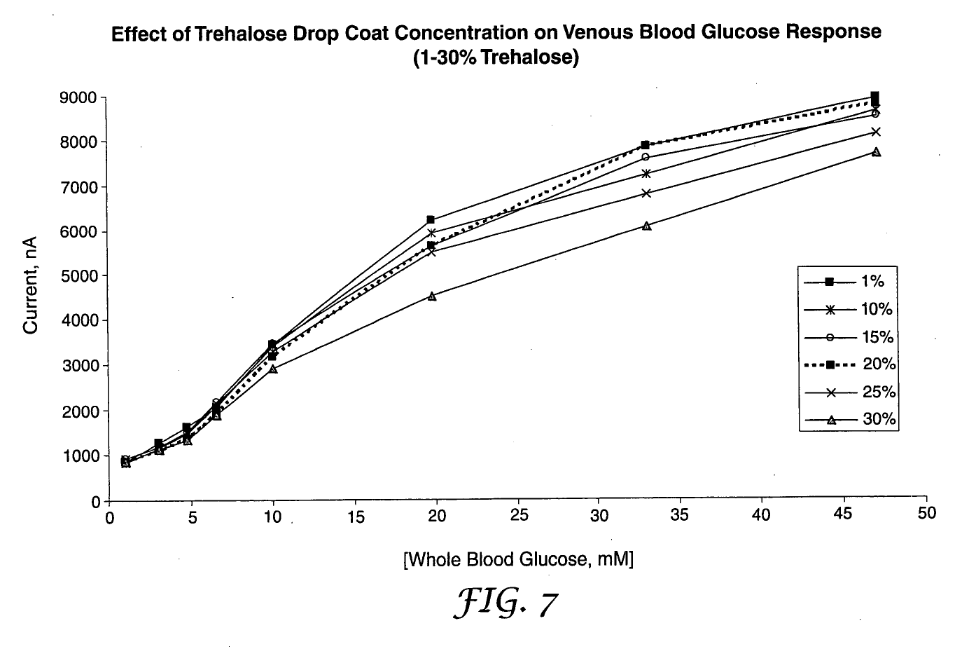

As shown in FIG. 7, varying trehalose concentration has little effect on the response to low glucose concentrations. Higher levels of trehalose are preferred because they enhance biosensor stability with little detriment to sensitivity at low glucose levels.

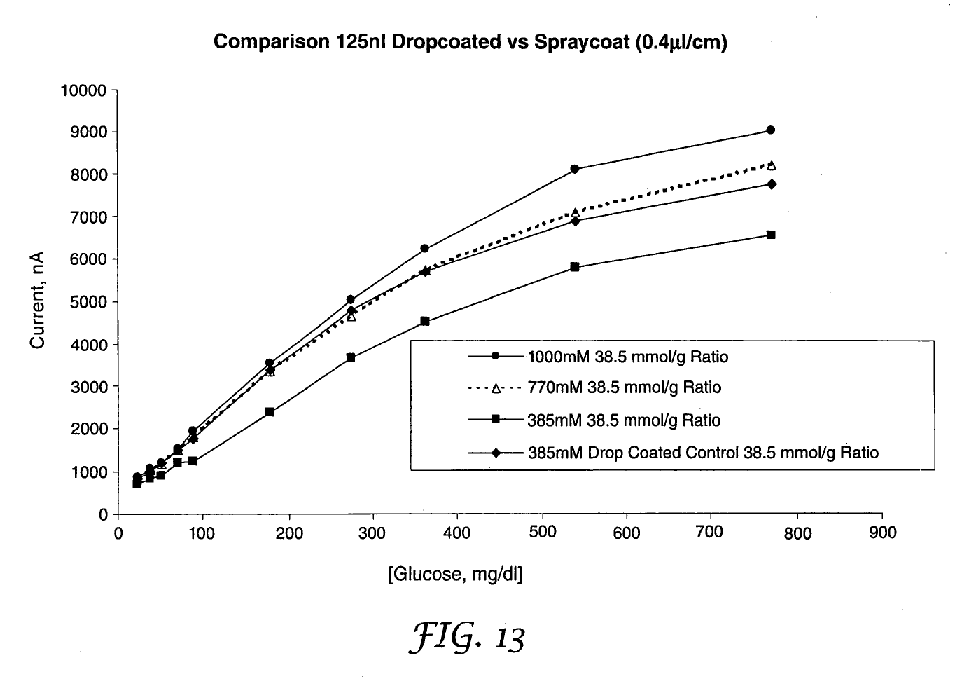

FIG. 13 shows results for spray-coating compared to drop-coating of the top layer. The drop-coating used a single 125 nl droplet from a BioDot apparatus. The spray-coating apparatus produced an atomised spray about 4 mm wide (slightly wider than the base layer 8) at a volume of 0.4 μl per cm of travel. Higher concentrations produce higher responses, notably for higher blood glucose concentration values. The drop-coated working electrode at 385 mM and 38.5 mmol/g showed a markedly better response than the spray-coated working electrode at the same concentration values.

It is appreciated that certain features of the invention, which are for clarity described in the context of separate embodiments, may also be provided in combination in a single embodiment. Conversely, various features of the invention which are, for the sake of brevity, described in the context of a single embodiment, may also be provided separately or in any suitable subcombination.

While the present invention has been described with reference to specific embodiments, it should be understood that modifications and variations of the invention may be constructed without departing from the spirit and scope of the invention defined in the following claims.

1. A non-mediated biosensor for indicating amperometrically the catalytic activity of an oxidoreductase enzyme in the presence of a fluid containing a substance acted upon by said enzyme, the biosensor comprising:
(a) a first substrate;
(b) a working electrode and a counter electrode on the first substrate;
(c) conductive tracks connected to said electrodes for making electrical connections with a test meter apparatus;
(d) a second substrate overlying at least a part of the first substrate; and
(e) a spacer layer having a channel therein and disposed between the first substrate and the second substrate, the spacer layer channel co-operating with adjacent surfaces to define a capillary flow path which does not contain a mesh and which extends from an edge of at least one of said substrates to said electrodes;
wherein the working electrode includes:
(f) an electrically-conductive base layer comprising particles of finely divided platinum-group metal or platinum-group metal oxide bonded together by a resin;
(g) a top layer on the base layer, said top layer comprising a buffer; and
(h) a catalytically-active quantity of said oxidoreductase enzyme in at least one of said base layer and said top layer.

2. A biosensor according to claim 1, wherein the buffer is selected from a group comprising: phosphate, ADA, MOPS, MES, HEPES, ACA, and ACES, or buffers with a pKa 7.4±1.

3. A biosensor according to claim 1, wherein the buffer has a pH in the range 7 to 10.

4. A biosensor according to claim 3, wherein the buffer has a pH in the range 7 to 8.5.

5. A biosensor according to claim 1, further including a system stabiliser in the top layer, comprising a polyol which is not acted upon by the enzyme.

6. A biosensor according to claim 5, wherein the system stabiliser is trehalose.

7. A biosensor according to claim 1, wherein the oxidoreductase enzyme is glucose oxidase.

8. A biosensor according to claim 1, wherein the base layer also contains particles of finely-divided carbon or graphite.

9. A biosensor according to claim 8, wherein said finely divided particles of platinum group metal or oxide are carried on the surface of the finely-divided carbon or graphite.

10. A biosensor according to claim 8, wherein the finely divided particles comprise carbon, and wherein the base layer further includes a blocking agent for blocking active sites of the carbon.

11. A biosensor according to claim 10, wherein said blocking agent comprises a protein or a polyol.

12. A biosensor according to claim 11, wherein the blocking agent is bovine serum albumin (BSA) or trehalose.

13. A biosensor according to claim 1, wherein said oxidoreductase enzyme is located substantially in said top layer.

14. A biosensor according to claim 1, wherein the ratio of buffer to enzyme is in the range 10-70 mol/kg.

15. A biosensor according to claim 14, wherein the ratio of buffer to enzyme is in the range 20-40 mol/kg.

16. A biosensor according to claim 1, wherein the capillary flow path extends from parallel edges of both the first and second substrate to the electrodes.

17. A biosensor according to claim 1, wherein the counter electrode also functions as a reference electrode.

18. A non-mediated biosensor for indicating amperometrically the catalytic activity of an oxidoreductase enzyme in the presence of a fluid containing a substance acted upon by said enzyme, the biosensor comprising:
(a) a first substrate;
(b) a working electrode and a combined reference and counter electrode on the first substrate;
(c) conductive tracks connected to said electrodes for making electrical connections with a test meter apparatus;
(d) a second substrate overlying the first substrate; and
(e) a spacer layer having a channel therein and disposed between the first substrate and the second substrate, the spacer layer channel co-operating with adjacent surfaces to define a capillary flow path which does not contain a mesh and which extends from an edge of at least one of said substrates to said electrodes;
wherein the working electrode includes:
(f) an electrically-conductive base layer comprising particles of finely divided platinum-group metal or platinum-group metal oxide bonded together by a resin;
(g) a top layer on the base layer, said top layer comprising a buffer; and
(h) a catalytically-active quantity of said oxidoreductase enzyme in at least one of said base layer and said top layer.

19. A method of manufacturing a non-mediated biosensor for indicating amperometrically the catalytic activity of an oxidoreductase enzyme in the presence of a fluid containing a substance acted upon by said enzyme, the method comprising the steps of:
(a) taking a first substrate having a working electrode and a counter electrode thereon, and conductive tracks connected to said working and reference electrodes for making electrical connections with a test meter apparatus;
(b) wherein said working electrode is formed by printing on one of said conductive tracks an ink containing finely divided platinum-group metal or platinum-group metal oxide and a resin binder;
(c) causing or permitting said printed ink to dry to form an electrically conductive base layer comprising said platinum-group metal or platinum-group metal oxide bonded together by the resin;
(d) forming a top layer on the base layer by coating the base layer with a coating medium comprising or containing a buffer; wherein
(e) a catalytically active quantity of said oxidoreductase enzyme is provided in at least one of the printed ink and the coating medium;
(f) providing a second substrate overlying part of the first substrate; and
(g) providing a spacer layer having a channel therein and disposed between the first substrate and the second substrate, whereby the spacer layer channel and adjacent surfaces together define a capillary flow path which does not contain a mesh and which extends from an edge of at least one of said substrates to said electrodes.

20. A method according to claim 19, wherein the coating medium is a coating fluid containing the buffer and wherein the method further comprises causing or permitting said coating fluid to dry to form a top layer on the base layer.

21. A method according to claim 20, wherein the coating fluid is applied by spray coating.

22. A method according to claim 20, wherein the coating fluid has a pH in the range 7 to 8.5.

23. A method according to claim 20, wherein the concentration of buffer in the coating fluid is in the range 300 mmol/l to 1 mol/l.

24. A method according to claim 20, wherein the coating fluid is applied by drop coating.

25. A method according to claim 24, wherein the volume of coating fluid applied to the base layer is in the range 90-160 nl.

26. A method according to claim 19, wherein said enzyme is provided in the coating medium.

27. A method according to claim 19, wherein the ratio of buffer to enzyme is in the range 10-70 mmol/g.

28. A method according to claim 27, wherein the ratio of buffer to enzyme is in the range 20-40 mmol/g.

29. A method according to claim 19, wherein the buffer comprises phosphate or ADA.

30. A method according to claim 19, wherein said finely divided platinum group metal or platinum group metal oxide in said ink is carried on the surface of particles of finely divided carbon or graphite.

31. A method according to claim 19, wherein the spacer layer is formed by printing a UV-curable composition on the first substrate and then curing the composition.

32. A method according to claim 19, wherein the spacer layer comprises double-sided adhesive tape.

33. A method according to claim 19, wherein the second substrate comprises a plastics material having a hydrophilic inner surface.

34. A method according to claim 33, wherein said hydrophilic inner surface comprises a heat-sealable adhesive whereby the second substrate may be adhered to the spacer layer by the action of heat and pressure.
